(19) United States
(12) Patent Application Publication
(10) Pub. No.: US 2023/0030877 A1
(43) Pub. Date: Feb. 2, 2023

(54) Metal powder for additive manufacturing

(71) Applicant: ArcelorMittal, Luxembourg (LU)

(72) Inventors: Valérie DAESCHLER, Maizières-lès-Metz (FR); Frédéric BONNET, Maizières-lès-Metz (FR); Rosalia REMENTERIA FERNANDEZ, Avilés, Asturias (ES); Diego Alejandro SEGOVIA PEREZ, Avilés, Asturias (ES)

(21) Appl. No.: 17/785,611

(22) PCT Filed: Dec. 20, 2019
(86) PCT No.: PCT/IB2019/061160

§ 371 Date: Jun. 15, 2022

(51) Int. Cl. B22F 1/065; B22F 1/052; C22C 1/03; C22C 38/58; C22C 38/54; C22C 38/50; C22C 38/48; C22C 38/46; C22C 38/44; C22C 38/42; C22C 38/06; C22C 38/02; C22C 38/00

(52) U.S. Cl. CPC B22F 1/065; B22F 1/052; C22C 1/03; C22C 38/58; C22C 38/54; C22C 38/50; C22C 38/48; C22C 38/46; C22C 38/44; C22C 38/42; C22C 38/06; C22C 38/02; C22C 38/002; B33Y 70/00

(57) ABSTRACT

A metal powder for additive manufacturing having a composition including the following elements, expressed in content by weight: 0.01%≤C≤0.2%, 2.5%≤Ti≤10%, (0.45×Ti)−1.35%≤B≤(0.45×Ti)+0.70%, S≤0.03%, P≤0.04%, N≤0.05%, O≤0.05% and optionally containing: Si≤1.5%, Mn≤3%, Al≤1.5%, Ni≤1%, Mo≤1%, Cr≤3%, Cu≤1%, Nb≤0.1%, V≤0.5% and including eutectic precipitates of TiB₂ and optionally of Fe₂B, the balance being Fe and unavoidable impurities resulting from the elaboration, the metal powder having a mean roundness of at least 0.70. The invention also relates to its manufacturing method by argon atomization.

The present invention relates to a metal powder for the manufacturing of steel parts and in particular for their use for additive manufacturing. The present invention also relates to the method for manufacturing the metal powder.

### SUMMARY OF THE INVENTION

FeTiB₂ steels have been attracting much attention due to their excellent high elastic modulus E, low density and high tensile strength. However, such steel sheets are difficult to produce by conventional routes with a good yield, which limits their use.

It is an object of the present invention to remedy such drawbacks by providing FeTiB₂ powders that can be efficiently used to manufacture parts by additive manufacturing methods while maintaining good use properties.

The present invention provides a metal powder for additive manufacturing having a composition comprising the following elements, expressed in content by weight:

0.01%≤C≤0.2%

2.5%≤Ti≤10%

(0.45×Ti)−1.35%≤B≤(0.45×Ti)+0.70%

S≤0.03%

P≤0.04%

N≤0.05%

O≤0.05%
and optionally containing:

Si≤1.5%

Mn≤3%

Al≤1.5%

Ni≤1%

Mo≤1%

Cr≤3%

Cu≤1%

Nb≤0.1%

V≤0.5%
and comprising precipitates of TiB₂ and optionally of Fe₂B, the balance being Fe and unavoidable impurities resulting from the elaboration, the metal powder having a mean roundness of at least 0.70.

A second subject of the invention consists of a method for manufacturing a metal powder for additive manufacturing, comprising:
melting elements and/or metal-alloys at a temperature at least 50° C. above the liquidus temperature so as to obtain a molten composition comprising, expressed in content by weight, 0.01%≤C≤0.2%, 2.5%≤Ti≤10%, (0.45×Ti)−1.35%≤B≤(0.45×Ti)+0.70%, S≤0.03%, P≤0.04%, N≤0.05%, O≤0.05% and optionally containing Si≤1.5%, Mn≤3%, Al≤1.5%, Ni≤1%, Mo≤1%, Cr≤3%, Cu≤1%, Nb≤0.1%, V≤0.5%, the balance being Fe and unavoidable impurities resulting from the elaboration and
atomizing the molten composition through a nozzle with pressurized argon.

A third subject of the invention consists of a metal part manufactured by an additive manufacturing process using a metal power according to the invention or obtained through the method according to the invention.

### BRIEF DESCRIPTION OF THE DRAWINGS

The invention will be better understood by reading the following description, which is provided purely for purposes of explanation and is in no way intended to be restrictive, with reference to:

FIG. 1, which is a micrograph of a powder outside of the invention, obtained by atomization with nitrogen

FIG. 2, which is a micrograph of a powder according to the invention, obtained by atomization with argon.

### DETAILED DESCRIPTION

The powder according to the invention has a specific composition, balanced to obtain good properties when used for manufacturing parts.

The carbon content is limited because of the weldability as the cold crack resistance and the toughness in the HAZ (Heat Affected Zone) decrease when the carbon content is greater than 0.20%. When the carbon content is equal to or less than 0.050% by weight, the resistance weldability is particularly improved.

Because of the titanium content of the steel, the carbon content is preferably limited so as to avoid primary precipitation of TiC and/or Ti(C,N) in the liquid metal. The maximum carbon content must be preferably limited to 0.1% and even better to 0.080% so as to produce the TiC and/or Ti(C,N) precipitates predominantly during solidification or in the solid phase.

Silicon is optional but when added contributes effectively to increasing the tensile strength thanks to solid solution hardening. However, excessive addition of silicon causes the formation of adherent oxides that are difficult to remove. To maintain good surface properties, the silicon content must not exceed 1.5% by weight.

Manganese is optional. However, in an amount equal to or greater than 0.06%, manganese increases the hardenability and contributes to the solid-solution hardening and therefore increases the tensile strength. It combines with any sulfur present, thus reducing the risk of hot cracking. But, above a manganese content of 3% by weight, there is a greater risk of forming deleterious segregation of the manganese during solidification.

Aluminum is optional. However, in an amount equal to or greater than 0.005%, aluminum is a very effective element for deoxidizing the steel. But, above a content of 1.5% by weight, excessive primary precipitation of alumina takes place, causing processing problems.

In an amount greater than 0.030%, sulfur tends to precipitate in excessively large amounts in the form of manganese sulfides which are detrimental.

Phosphorus is an element known to segregate at the grain boundaries. Its content must not exceed 0.040% to maintain sufficient hot ductility, thereby avoiding cracking.

Optionally, nickel, copper or molybdenum may be added, these elements increasing the tensile strength of the steel. For economic reasons, these additions are limited to 1% by weight.

Optionally, chromium may be added to increase the tensile strength. It also allows larger quantities of carbides to be precipitated. However, its content is limited to 3% by weight to manufacture a less expensive steel. A chromium content equal to or less than 0.080% will preferably be chosen. This is because an excessive addition of chromium results in more carbides being precipitated.

Also optionally, niobium and vanadium may be added respectively in an amount equal to or less than 0.1% and equal to or less than 0.5% so as to obtain complementary hardening in the form of fine precipitated carbonitrides.

Titanium and boron play an important role in the powder according to the invention.

Titanium is present in amount between 2.5% and 10%. When the weight content of titanium is less than 2.5%, TiB₂ precipitation does not occur in sufficient quantity. This is because the volume fraction of precipitated TiB2 is less than 5%, thereby precluding a significant change in the elastic modulus, which remains less than 220 GPa. When the weight content of titanium is greater than 10%, coarse primary TiB2 precipitation occurs in the liquid metal and causes problems in the products. Moreover, liquidus point increases so that a minimum of superheat of 50° C. cannot be achieved anymore, making the powder manufacturing impossible to perform.

FeTiB₂ eutectic precipitation occurs upon solidification. The eutectic nature of the precipitation gives the microstructure formed a particular fineness and homogeneity advantageous for the mechanical properties. When the amount of TiB₂ eutectic precipitates is greater than 5% by volume, the elastic modulus of the steel measured in the rolling direction can exceed about 220 GPa. Above 10% by volume of TiB₂ precipitates, the modulus may exceed about 240 GPa, thereby enabling appreciably lightened structures to be designed. This amount may be increased to 15% by volume to exceed about 250 GPa, in the case of steels comprising alloying elements such as chromium or molybdenum. This is because when these elements are present, the maximum amount of TiB2 that can be obtained in the case of eutectic precipitation is increased.

As explained above, titanium must be present in sufficient amount to cause endogenous TiB₂ formation.

According to the invention, titanium may also be present by being dissolved at ambient temperature in the matrix in a sub-stoichiometric proportion relative to boron, calculated based on TiB₂. To get such a hypoeutectic steel, the titanium content is preferably such that: 2.5%≤Ti≤4.6%. When the weight content of titanium is below 4.6%, TiB₂ precipitation takes place in such a way that the precipitated volume fraction is lower than 10%. The elastic modulus is then between 220 GPa and about 240 GPa.

According to the invention, titanium may also be present by being dissolved at ambient temperature in the matrix in a super-stoichiometric proportion relative to boron, calculated based on TiB₂. To get such a hypereutectic steel, the titanium content is preferably such that: 4.6%≤Ti≤10%. When the weight content of titanium is equal to or greater than 4.6%, TiB₂ precipitation takes place in such a way that the precipitated volume fraction is equal to or greater than 10%. The elastic modulus is then equal to or greater than about 240 GPa.

The weight contents expressed in percent of titanium and boron of the steel are such that:

(0.45×Ti)−1.35%≤B≤(0.45×Ti)+0.70%

which can be expressed equivalently as:

−1.35≤B−(0.45×Ti)≤0.70

If the weight contents of titanium and boron are such that:
B−(0.45×Ti)>0.70, there is excessive Fe₂B precipitation, which degrades the ductility,
−1.35<B−(0.45×Ti), there is not enough precipitation of TiB₂.

In the frame of the present invention, the “free Ti” here designates the content of Ti not bound under the form of precipitates. The free Ti content can be evaluated as free Ti=Ti−2.215×B, B designating the B content in the powder. Depending on the value of such free Ti, the microstructure of the powder will be different, which will now be described.

According to a first embodiment of the invention, the titanium amount is at least 3.2% and the titanium and boron weight contents are such that

(0.45×Ti)−1.35≤B≤(0.45×Ti)−0.43

In that composition domain, the free Ti content is above 0.95% and the microstructure of the powder is mainly ferritic whatever the temperature (below T liquidus). By “mainly ferritic”, it must be understood that the structure of the powder consists of ferrite, precipitates (especially TiB₂ precipitates) and at most 10% of austenite. As a result, the hot hardness of the powder is significantly reduced as compared to the steels of the state of the art, so that the hot formability is strongly increased.

According to a second embodiment of the invention, the titanium and boron contents are such that:

−0.35≤B−(0.45×Ti)<−0.22

When the quantity B−(0.45×Ti) is equal to or greater than −0.35 and less than −0.22, the amount of free Ti is comprised between 0.5 and 0.8%. This amount proves to be particularly suitable for obtaining precipitation composed solely of TiB₂, without precipitation of Fe₂B. The amount of titanium dissolved in the matrix is quite low, which means that the additions of titanium are particularly effective from an productivity standpoint.

According to a third embodiment of the invention, the titanium and boron contents are such that:

−0.22≤B−(0.45×Ti)≤0.70

In that range, the content of free Ti is less than 0.5%. The precipitation takes place in the form of two successive eutectics: firstly, FeTiB₂ and then Fe₂B, this second endogenous precipitation of Fe₂B taking place in a greater or lesser amount depending on the boron content of the alloy. The amount precipitated in the form of Fe₂B may range up to 8% by volume. This second precipitation also takes place according to a eutectic scheme, making it possible to obtain a fine uniform distribution, thereby ensuring good uniformity of the mechanical properties.

The precipitation of Fe₂B completes that of TiB₂, the maximum amount of which is linked to the eutectic. The Fe₂B plays a role similar to that of TiB₂. It increases the elastic modulus and reduces the density. It is thus possible for the mechanical properties to be finely adjusted by varying the complement of Fe₂B precipitation relative to TiB₂ precipitation. This is one means that can be used in particular to obtain an elastic modulus greater than 250 GPa in the steel and an increase in the tensile strength of the product. When the steel contains an amount of Fe₂B equal to or greater than 4% by volume, the elastic modulus increases by more than 5 GPa. When the amount of Fe₂B is greater than 7.5% by volume, the elastic modulus is increased by more than 10 GPa.

The morphology of the metal powder according to the invention is particularly good.

Indeed, the mean roundness of the metal powder according to the invention is of a minimum value of 0.70, preferably of at least 0.75. The mean roundness is defined as b/l, wherein l is the longest dimension of the particle projection and b is the smallest. Roundness is the measure of how closely the shape of a powder particle approaches that of a mathematically perfect circle, which has a roundness of 1.0. Thanks to this high roundness, the metal powder is highly flowable. Consequently, the additive manufacturing is made easier and the printed parts are dense and hard.

In a preferred embodiment, the mean sphericity SPHT of the metal powder according to the invention is also improved, with a minimum value of 0.75, preferably of a least 0.80.

The mean sphericity can be measured by a Camsizer and is defined in ISO 9276-6 as 4πA/P², where A is the measured area covered by a particle projection and P is the measured perimeter/circumference of a particle projection. A value of 1.0 indicates a perfect sphere.

Preferably, at least 75% of the metal powder particles have a size in the range of 15 μm to 170 μm, as measured by laser diffraction according to ISO13320:2009 or ASTM B822-17.

The powder can be obtained, for example, by first mixing and melting pure elements and/or ferroalloys as raw materials. Alternatively, the powder can be obtained by melting pre-alloyed compositions.

Pure elements are usually preferred to avoid having too much impurities coming from the ferroalloys, as these impurities might ease the crystallization. Nevertheless, in the case of the present invention, it has been observed that the impurities coming from the ferroalloys were not detrimental to the achievement of the invention.

The person skilled in the art knows how to mix different ferroalloys and pure elements to reach a targeted composition.

Once the composition has been obtained by the mixing of the pure elements and/or ferroalloys in appropriate proportions, the composition is heated at a temperature at least 100° C. above its liquidus temperature and maintain at this temperature to melt all the raw materials and homogenize the melt. Thanks to this overheating, the decrease in viscosity of the melted composition helps obtaining a powder with good properties. That said, as the surface tension increases with temperature, it is preferred not to heat the composition at a temperature more than 450° C. above its liquidus temperature.

Preferably, the composition is heated at a temperature at least 100° C. above its liquidus temperature. More preferably, the composition is heated at a temperature 300 to 400° C. above its liquidus temperature.

The molten composition is then atomized into fine metal droplets by forcing a molten metal stream through an orifice, the nozzle, at moderate pressures and by impinging it with jets of gas (gas atomization) or of water (water atomization). In the case of the gas atomization, the gas is introduced into the metal stream just before it leaves the nozzle, serving to create turbulence as the entrained gas expands (due to heating) and exits into a large collection volume, the atomizing tower. The latter is filled with gas to promote further turbulence of the molten metal jet. The metal droplets cool down during their fall in the atomizing tower. Gas atomization is preferred because it favors the production of powder particles having a high degree of roundness and a low amount of satellites.

The atomization gas is argon. It increases the melt viscosity slower than other gases, e.g. helium, which promotes the formation of smaller particle sizes. It also controls the purity of the chemistry, avoiding undesired impurities, and plays a key role in the good morphology of the powder, as will be evidenced in the examples.

The gas pressure is of importance since it directly impacts the particle size distribution and the microstructure of the metal powder. In particular, the higher the pressure, the higher the cooling rate. Consequently, the gas pressure is set between 10 and 30 bar to optimize the particle size distribution and favor the formation of the micro/nano-crystalline phase. Preferably, the gas pressure is set between 14 and 18 bar to promote the formation of particles whose size is most compatible with the additive manufacturing techniques.

The nozzle diameter has a direct impact on the molten metal flow rate and, thus, on the particle size distribution and on the cooling rate. The maximum nozzle diameter is usually limited to 4 mm to limit the increase in mean particle size and the decrease in cooling rate. The nozzle diameter is preferably between 2 and 3 mm to more accurately control the particle size distribution and favor the formation of the specific microstructure.

The gas to metal ratio, defined as the ratio between the gas flow rate (in Kg/h) and the metal flow rate (in Kg/h), is preferably kept between 1.5 and 7, more preferably between 3 and 4. It helps adjusting the cooling rate and thus further promotes the formation of the specific microstructure.

According to one variant of the invention, in the event of humidity uptake, the metal powder obtained by atomization is dried to further improve its flowability. Drying is preferably done at 100° C. in a vacuum chamber.

The metal powder obtained by atomization can be either used as such or can be sieved to keep the particles whose size better fits the additive manufacturing technique to be used afterwards. For example, in case of additive manufacturing by Powder Bed Fusion, the range 20-63 μm is preferred. In the case of additive manufacturing by Laser Metal Deposition or Direct Metal Deposition, the range 45-150 μm is preferred.

The parts made of the metal powder according to the invention can be obtained by additive manufacturing techniques such as Powder Bed Fusion (LPBF), Direct metal laser sintering (DMLS), Electron beam melting (EBM), Selective heat sintering (SHS), Selective laser sintering (SLS), Laser Metal Deposition (LMD), Direct Metal Deposition (DMD), Direct Metal Laser Melting (DMLM), Direct Metal Printing (DMP), Laser Cladding (LC), Binder Jetting (BJ), Coatings made of the metal powder according to the invention can also be obtained by manufacturing techniques such as Cold Spray, Thermal Spray, High Velocity Oxygen Fuel.

### Examples

The following examples and tests presented hereunder are non-restricting in nature and must be considered for purposes of illustration only. They will illustrate the advantageous features of the present invention, the significance of the parameters chosen by inventors after extensive experiments and further establish the properties that can be achieved by the metal powder according to the invention.

Metal compositions according to Table 1 were first obtained either by mixing and melting ferroalloys and pure elements in the appropriate proportions or by melting pre-alloyed compositions. The composition, in weight percentage, of the added elements are gathered in Table 1.

TABLE 1
Melt composition

| Sample | C | Ti | B | Mn | Al | Si | V | S | P | N | O | Ni | Cr | Cu |
|---|---|---|---|---|---|---|---|---|---|---|---|---|---|---|
| C103 | 0.044 | 5.88 | 1.68 | <0.001 | 0.326 | 0.439 | 0.220 | 0.006 | 0.002 | <0.001 | <0.001 | <0.001 | <0.001 | <0.001 |
| C157 | 0.021 | 5.99 | 1.96 | 0.186 | 0.115 | 0.069 | 0.047 | 0.002 | 0.009 | <0.001 | <0.001 | 0.044 | 0.033 | 0.053 |
| C30 | 0.022 | 5.48 | 1.73 | 0.080 | 0.021 | 0.062 | 0 | 0.007 | 0.0063 | 0.005 | 0.001 | 0.015 | 0.083 | 0.02 |
| C104 | 0.092 | 10.35 | 3.89 | <0.001 | 0.502 | 1.012 | 0.299 | 0.018 | 0.004 | <0.001 | <0.001 | <0.001 | <0.001 | <0.001 |
| C29 | 0.022 | 5.48 | 1.73 | 0.080 | 0.021 | 0.062 | 0 | 0.007 | 0.0063 | 0.005 | 0.001 | 0.015 | 0.083 | 0.02 |
| C14 | 0.022 | 5.48 | 1.73 | 0.080 | 0.021 | 0.062 | 0 | 0.007 | 0.0063 | 0.005 | 0.001 | 0.015 | 0.083 | 0.02 |
| C26 | 0.019 | 4.81 | 1.99 | 0.189 | 0.046 | 0.068 | 0 | 0.001 | 0.0090 | <0.001 | <0.001 | 0.045 | 0.033 | 0.05 |

These metal compositions were heated up and then gas atomized with argon or nitrogen in the process conditions gathered in Table 2.

TABLE 2
Atomization parameters

| | Overheat | Holding | Atom T | Atom | Gas T | Atom t, | | | |
|---|---|---|---|---|---|---|---|---|---|
| Batch | T(° C.) | t (min) | (° C.) | gas | (° C.) | mm:ss | F1, % | F2, % | F3, % |
| C103 | 350 | 60 | 1645 | Ar | RT | 1:24 | 13.8 | 28.6 | 36.1 |
| C157 | 350 | 30 | 1641 | Ar | RT | 1:20 | 18 | 43.2 | 29.6 |
| C30 | 100 | 45 | 1395 | N₂ | 200 | 1:10 | 10.4 | 22.9 | 37.2 |
| C104 | 65 | 60 | 1645 | Ar | RT | 1:20 | 15.2 | 30.9 | 35.3 |
| C29 | 100 | 45 | 1389 | N₂ | 200 | 1:12 | 9.2 | 21.3 | 35.9 |
| C14 | 403 | 15 | 1696 | N₂ | RT | 1:08 | 12.1 | 22.5 | 35.0 |
| C26 | 260 | 50 | 1556 | N₂ | 400 | 1:07 | 12.4 | 19.0 | 33.9 |

RT means room temperature

For all trials, the common input parameters of the atomizer BluePower AU3000 were:

| | |
|---|---|
| Start ΔP | 60 mbar |
| End ΔP | 140 mbar |
| Time ΔP | 1.5 min |
| Argon Gas Pressure | 24 bar |
| Gas Start Delay Time | 1-2 s |
| Crucible/Stopper Rod Material | Al₂O₃/Al₂O₃ |
| Crucible Outlet Diameter | 3.0 mm |
| Crucible Outlet Material | Boron Nitride |

The obtained metal powders were then dried at 100° C. under vacuum for 0.5 to 1 day and sieved to be separated in three fractions F1 to F3 according to their size.

The elemental composition of the powders, in weight percentage, was analyzed and main elements were gathered in table 3. All other elements contents were within the invention ranges.

TABLE 3
Powder composition

| Sample | Ti | B | TiB₂ | Fe₂B |
|---|---|---|---|---|
| C103 | 5.34 | 1.73 | Yes | No |
| C157 | 5.84 | 2.05 | Yes | No |
| C30 | 5.34 | 1.72 | Yes | No |
| C104 | 8.28 | 3.13 | Yes | No |
| C29 | 5.37 | 1.70 | Yes | No |
| C14 | 5.30 | 1.71 | Yes | No |
| C26 | 4.99 | 2.04 | Yes | Yes |

The morphology of the F1 fraction of the powders, gathering the powder particles with a size between 1 and 19 μm was determined and gathered in table 4.

TABLE 4
F1 fraction morphology

| | ΔT | | F1 fraction | |
|---|---|---|---|---|
| Sample | (° C.) | Atm | Round | SPHT |
| C103* | 350 | Ar | 0.77 | 0.87 |
| C157* | 350 | Ar | 0.76 | 0.87 |
| C30 | 100 | N₂ | 0.65 | 0.74 |

*samples according to the invention, underlined values: out of the invention

The morphology of the F2 fraction of the powders, gathering the powder particles with a size between 20 and 63 μm was determined and gathered in table 5.

TABLE 5
F2 fraction morphology

| | ΔT | | F2 fraction | |
|---|---|---|---|---|
| Sample | (° C.) | Atm | Round | SPHT |
| C103* | 350 | Ar | 0.76 | 0.81 |
| C157* | 350 | Ar | 0.79 | 0.82 |
| C104* | 65 | Ar | 0.77 | 0.84 |
| C29 | 100 | N₂ | 0.62 | 0.72 |
| C30 | 100 | N₂ | 0.64 | 0.71 |

*samples according to the invention, underlined values: out of the invention

The morphology of the F3 fraction of the powders, gathering the powder particles with a size above 64 μm was determined and gathered in table 6

TABLE 6
F3 fraction morphology

| | ΔT | | F3 fraction | |
|---|---|---|---|---|
| Sample | (° C.) | Atm | Round | SPHT |
| C103* | 350 | Ar | 0.73 | 0.78 |
| C157* | 65 | Ar | 0.82 | 0.80 |
| C104* | 350 | Ar | 0.80 | 0.79 |
| C14 | 403 | N₂ | 0.63 | 0.74 |
| C26 | 260 | N₂ | 0.59 | 0.68 |
| | | | F3 fraction | |
| C29 | 100 | N₂ | 0.60 | 0.70 |

*samples according to the invention, underlined values: out of the invention

It is clear from the examples that all fractions of the powder according to the invention present an improved morphology and especially an improved mean roundness, compared to the reference examples.

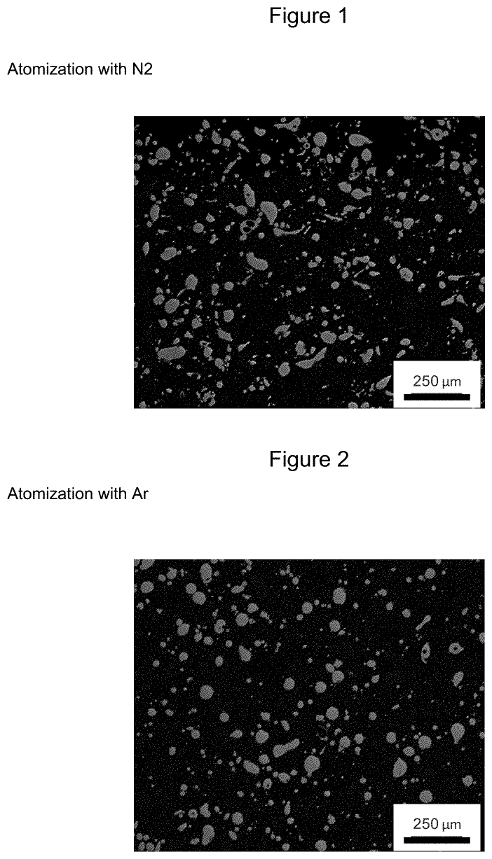

This is confirmed by the micrographs shown as FIGS. 1 and 2, wherein the improved morphology of the powders according to the invention, shown in FIG. 2 is clearly visible.

What is claimed is:

1-14. (canceled)

15. A metal powder for additive manufacturing having a composition comprising the following elements, expressed in content by weight:
0.01%≤C≤0.2%
2.5%≤Ti≤10%
(0.45×Ti)−1.35%≤B≤(0.45×Ti)+0.70%
S≤0.03%
P≤0.04%
N≤0.05%
O≤0.05%
and optionally including:
Si≤1.5%
Mn≤3%
Al≤1.5%
Ni≤1%
Mo≤1%
Cr≤3%
Cu≤1%
Nb≤0.1%
V≤0.5%
and including precipitates of TiB₂ and optionally of Fe₂B, a balance being Fe and unavoidable impurities resulting from processing, the metal powder having a mean roundness of at least 0.70.

16. The metal powder as recited in claim 15 wherein the metal powder has a mean sphericity of at least 0.75.

17. The metal powder as recited in claim 15 wherein 75% of the particles composing the metal powder have a size in the range of 15 μm to 170 μm.

18. The metal powder as recited in claim 15 wherein at least 35% of the particles composing the metal powder have a size in the range of 20 to 63 μm.

19. The metal powder as recited in claim 15 wherein 3.2%≤Ti≤10% and (0.45×Ti)−1.35%≤B≤(0.45×Ti)−0.43%.

20. The metal powder as recited in claim 15 wherein (0.45×Ti)−0.35%≤B<(0.45×Ti)−0.22%.

21. The metal powder as recited in claim 15 wherein the powder comprises the precipitates of Fe₂B.

22. The metal powder as recited in claim 15 wherein 4.6%≤Ti≤10%

23. The metal powder as recited in claim 15 wherein 2.5%≤Ti≤4.6%

24. A method for manufacturing a metal powder for additive manufacturing, the method comprising:
melting elements or metal-alloys at a temperature at least 50° C. above the liquidus temperature so as to obtain a molten composition comprising, expressed in content by weight, 0.01%≤C≤0.2%, 2.5%≤Ti≤10%, (0.45×Ti)−1.35%≤B≤(0.45×Ti)+0.70%, S≤0.03%, P≤0.04%, N≤0.05%, O≤0.05% and optionally including Si≤1.5%, Mn≤3%, Al≤1.5%, Ni≤1%, Mo≤1%, Cr≤3%, Cu≤1%, Nb≤0.1%, V≤0.5%, a balance being Fe and unavoidable impurities resulting from the elaboration and
atomizing the molten composition through a nozzle with pressurized argon.

25. The method as recited in claim 24 wherein the melting is at a temperature at least 100° C. above the liquidus temperature.

26. The method as recited in claim 24 wherein the melting is at a temperature at maximum 400° C. above the liquidus temperature.

27. The method as recited in claim 24 wherein the gas is pressurized between 10 and 30 bar.

28. A metal part obtained according to the method as recited in claim 24.

29. A metal part manufactured by an additive manufacturing process using a metal power as recited in claim 15.
